(19) United States
(12) Patent Application Publication
(10) Pub. No.: US 2024/0106856 A1
(43) Pub. Date: Mar. 28, 2024

(54) Real-Time Anomaly Detection and Rapid Mitigation in a Hybrid Cloud Environment

(71) Applicant: Panzura LLC, Plano, TX (US)

(72) Inventors: Hamid Fahim, Cleveland, OH (US); Aisian Gomide Foina, Realeza (BR); Edward M. Peters, Irving, TX (US); Jian Xing, Pleasanton, CA (US); Carlos J. Zúñiga-Aguilar, Guadalajara (MX); Arturo Rodriguez-Cristerna, Mexico City (MX)

(73) Assignee: Panzura LLC, Plano, TX (US)

(21) Appl. No.: 18/474,185

(22) Filed: Sep. 25, 2023

Related U.S. Application Data
(60) Provisional application No. 63/376,727, filed on Sep. 22, 2022.

(51) Int. Cl. H04L 9/40

(52) U.S. Cl. CPC H04L 63/1466; H04L 63/1425

(57) ABSTRACT

A distributed data security event detection and response (DDSEDR) system includes a data security management (DSM) system and a client-side data security event confirmation and response (CDSECR) system that manage data security events, such as ransomware attacks. In at least one embodiment, the DDSEDR system provides data security event detection, confirmation, mitigation, alerting, and recovery from malicious processes and other data security events. In at least one embodiment, the DSM system monitors one or more client file event records for information that indicates a potential data security event. If the DSM system detects a potential data security threat, the DSM, sends information to the CDSECR system that causes CDSECR system to inspect one or more files associated with the potential data security event to determine whether an actual data security event occurred and initiate a responsive action when the CDSECR system detects an actual data security event.

### CROSS-REFERENCE TO RELATED APPLICATION

This application claims the benefit under 35 U.S.C. § 119(e) and 37 C.F.R. § 1.78 of U.S. Provisional Application No. 63/376,727, filed Sep. 23, 2022, and entitled “Real-Time Anomaly Detection and Rapid Mitigation in a Hybrid Cloud Environment,” which is incorporated by reference in its entirety.

### BACKGROUND OF THE INVENTION

### Field of the Invention

This disclosure relates to data security and more specifically to a distributed data security event detection and response system and method.

### Description of the Related Art

An immense amount of data is stored worldwide. The estimated volume of data stored worldwide through 2022 is 97 zettabytes. Most data storage units are accessible over a network and, thus, are susceptible to a variety of malevolent actors, malicious processes, and numerous other data security threats. Malevolent actors and their accompanying malicious processes exist in many forms, such as ransomware, espionage, malevolent destruction of files or data, password leaks which lead to compromised data files, and any other actions or malware that affect the integrity of a set of files or other forms of data or violates the owner's control of the data.

Data security threats exist in a number of forms and are characterized by a variety of different types of malicious processes. For example, ransomware is a type of malicious software, and insertion and activation of ransomware interferes with files or data access by encrypting files or interrupting applications. This is often done to blackmail the victim into paying a ransom to restore the impacted set of files or data. File or data espionage involves the unauthorized access and potential theft of files or data. For example, corporate espionage can involve a rival seeking to gain confidential knowledge, and leak espionage involves a malevolent actor seeking to make public files or data without authorization. Malevolent destruction of files or data, such as a disgruntled employee or malware attack, is often characterized by an individual with permission to access files or data who damages or deletes files or data without authorization. Password leaks can lead to situations whereby an unauthorized user has improperly obtained the credentials of an authorized user and accesses private files or data.

There are two primary methods for dealing with malicious processes: prevention and, mitigation. Prevention involves installing software on a server or sending all files to a third party system, and all files are scanned by the server or the third party system to detect malware, including ransomware and viruses, and prevent a malicious process before any damage can be done. While there are several known methods to prevent malware, the difficulty arises when a user, acting under the color of authority, executes the malicious process. Mitigation involves dealing with the consequences of the malicious process. This can involve restoring files or data with back-ups, paying ransoms, disconnecting a malicious user, or accepting the destruction of files or data.

The importance of data security cannot be overstated. Data security breaches represent an existential and potentially costly threat to any entity that stores data including individuals, businesses, and organizations. Data security breaches can have significant negative consequences including loss of data, payment of ransoms, reputational loss, financial losses, reputational damage, and diminished or complete loss of customer trust.

### SUMMARY

In at least one embodiment, a method, of managing data security events includes accessing, with a data security management (DSM) system, one or more client file event records, wherein each client file event record is uniquely associated with a client file, the client node is separate from the DSM system, each of the client files includes primary file content separate from the associated client file event record, and the client file event record logs information directly related to the associated client file. The method also includes monitoring the one or more client file event records with the DSM system and detecting an indication of a potential data security event involving the one or more client files associated with the client file record. The method further includes upon detection by the DSM of the potential data security event, sending information to a client computing environment that causes a client-side data security event confirmation and response (CDSECR) system to inspect the one or more client files associated with the potential data security event to determine whether an actual data security event occurred and initiate a responsive action when the CDSECR determines an occurrence of an actual data security event.

In another embodiment, a distributed data security event detection and response system includes a data security management (DSM) system. The DSM system includes one or more processors and a memory, coupled to one or more processors. The memory includes stored code that when executed by the one or more processors causes the DSM system to perform operations including accessing one or more client file event records. Each client file event record is uniquely associated with a client, file, the client node is separate from the DSM system, each of the client files includes primary file content separate from the associated client file event record, and the client file event record logs information directly related to the associated, client file. The DSM system also performs operations that include monitoring the one or, more client file event records with the DSM system and detecting an indication of a potential data security event involving the one or more client files associated with the client file record. The DSM system also performs operations that further include upon detection by the DSM of the potential data security event, sending information to a client computing environment that causes a client-side data security event confirmation and response (CDSECR) system to inspect the one or more client files associated with the potential data security event to determine whether an actual data security event occurred and initiate a responsive action when the CDSECR determines an occurrence of an actual data security event.

In a further embodiment, a non-transitory, computer readable medium having code stored therein to manage data security events. Execution of the code by one or more processors causes the one or more processors to perform operations that include accessing, with a data security management (DSM) system, one or more client file event records, wherein each client file event record is uniquely associated with a client file, the client node is separate from the DSM system, each of the client files includes primary file content separate from the associated client file event record, and the client file event record logs information directly related to the associated client file. The method also includes monitoring the one or more client file event records with the DSM system and detecting an indication of a potential data security event involving the one or more client files associated with the client file record. The method further includes upon, detection by the DSM of the potential data security event, sending information to a client computing environment that causes a client-side data security event confirmation and response (CDSECR) system to inspect the one or more client files associated with the potential data security event to determine whether an actual data security event occurred and initiate a responsive action when the CDSECR determines an occurrence of an actual data security event.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts a distributed data security event detection and response process system.

FIG. 2 depicts a distributed data security event detection and response process.

FIG. 3 depicts an audit table of client file event records.

FIG. 4 depicts client-side data security event confirmation and response system actions taken in association with a data security event.

FIG. 5 depicts an exemplary computer system.

### DETAILED DESCRIPTION

A distributed data security event detection and response (DDSEDR) system and method includes a data security management (DSM) system and method and a client-side data security, event confirmation and response (CDSECR) system that manage data security events, and data security events include both actual and attempted data security breaches of file systems such as ransomware attacks and other malicious events involving data tiles. In at least one embodiment, the DDSEDR system provides real-time data security event detection, confirmation, mitigation, alerting, and recovery from, malicious processes and other data security events. In at least one embodiment, the DSM system monitors one or more client file event records for information that indicates a potential data security event. If the DSM system detects a potential data security threat, the DSM sends potential data security event (PDSE) information to the CDSECR system that causes the CDSECR system to inspect one or more files associated with the potential data security event to determine whether an actual data security event occurred and initiate a responsive action when the CDSECR system detects an actual data security event. The DDSEDR system's distribution of data security responsibilities and, corresponding data security operations provides a technological solution to a significant problem of providing comprehensive data security management within a computing environment while minimizing burdening the client node's resources.

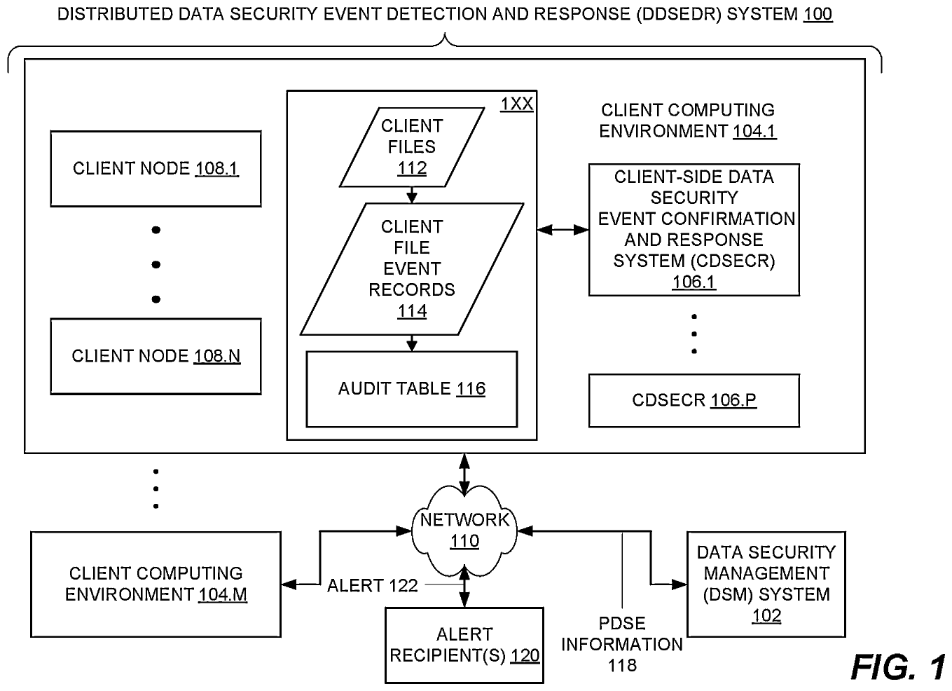

FIG. 1 depicts a distributed data security event detection and response (DDSEDR) system 100 includes a data security management (DSM) system 102 in communication with M client computing environments 104.1-104.M via network 110, such as the Internet. In at least one embodiment, the M client computing environments each include a client-side data security event confirmation and response (CDSECR) system 106.1-106.P that cooperatively operate with the DSM system 102 to provide data security detection, confirmation, mitigation, alerting, and recovery from malicious processes and other data security events for client nodes 108.1-108.N, where Nis an integer number having a value greater than or equal to 1 and can have a respective value for each client computer environment 104. M, N, and P are integer indexes each having a value greater than or equal to 1. When referring generally to one or more DSM systems or CDSECR systems, the index numbers are not used herein.

Each client node 108 receives data security event services from a CDSECR 106. In at least one embodiment, there is a one-to-one correspondence between CDSECR's 106 and client nodes 108. However, one or more of the CDSECR's 106 may be multi-tenant, and the particular ratio of client nodes 108 to CDSECRs 106 for each client computing environment 104 is a matter of design choice. For example, client computing environment 104.1 may have one client node 108.1 and one CDSECR systems 106.1, client computing environment 104.2 may also have one node and one CDSECR systems 106.1, client computing environment 104.3 may have 5 client nodes 108.1-108.5 and three CDSECR systems 106.1-106.3, client computing environment 104.4 may have 4 client nodes 108.1-108.4 and 4 CDSECR systems 106.1-106.4, and so on. In at least one embodiment, the CDSECR systems 106 are applications executed by client nodes 108. In at least one embodiment, the DDSEDR system 100 provides real-time data security, and in at least one embodiment, the DDSEDR system 100 provides latent data security using data recovery operations.

The DSM system 102 is part of the DDSEDR 100 but is outside of any internal network of any client computing environment 104, and, thus, separate from each client node 108 and each CDSECR system 106. Each client node 108 refers to any device that can send, receive, or route data and includes computers, routers, switches, virtual machines, cloud computers, and internet of things devices. In at least one embodiment, each client node 108 operates in a network environment within a particular client computing environment 104. In at least one embodiment, each particular client computing environment 104 is a computing infrastructure that provides computing resources and capabilities over a network.

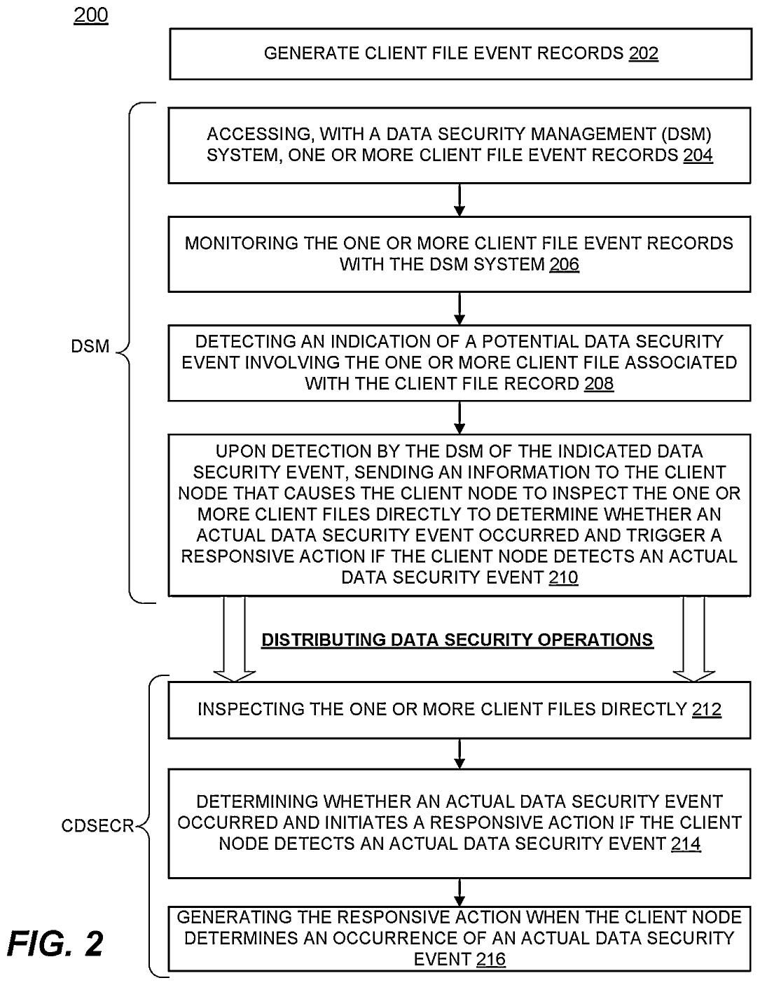

FIG. 2 depicts a DDSEDR method 200, and in at least one embodiment, the DDSEDR system 100 operates in accordance with DDSEDR method 200 to provide data security for the client nodes 108, Referring to FIGS. 1 and 2, the DSM system 102 and client computing environments 104 operate within the overall DDSEDR system 100. Within the DDSEDR system 100, the DSM system 103 and client nodes 108 distribute data security operations to detect, verify, and respond to data security events to minimize utilization of client node 108 resources while protecting client files 112. In operation 202, each client node 108 generates client file event records 114. In, at least one embodiment, each client node includes a file service application (not shown) that generates the client event records 114. In at least one embodiment, a file service application generates the client file event records for multiple client nodes 108. In at least one embodiment, each client file event record 114 is uniquely associated with a client file 112 stored in a client node 108 or in any other storage system including a database system.

In at least one embodiment, each of the client files 112 includes primary file content that is separate from the associated client file event record 114, and the client file event record logs information directly related to the associated client file 112. For example, in at least one embodiment, each client file event record logs information about a client file 112 whenever there is any activity involving the client file 102, such as any, access, read, write, deletion, and so on. In at least one embodiment, the client file event record is a type of metadata that is separate from the primary file content. In at least one embodiment, the primary file content refers to content for which the client file was actually generated. For example, a Microsoft Word® document contains information, such as a service manual, book, or other work other than a file name or file path that, is generated by a user. This information generated by the user is the primary file content. The client file event record contains information associated with the client file that is not the primary file content, such as a file name, file path, client node identifier, user, event, event details, and file size and/or a file name, a multipurpose Internet Mail Extension {MIME} type, an event time, and an activity type.

In operation 204, the DSM 102 accesses one or more of the client file event records 114. The matter of accessing the one or more client event records 114 is a matter of design choice. In at least one embodiment, a client node 108 stores multiple client file event records 114 in an optional audit table 116 and sends the audit table 116 to the DSM 102 periodically. In at least one embodiment, the client node 108 sends individual client file event records as client file events occur. In at least one embodiment, the DSM 102 accesses the one or more of the client file event records 114 from a memory location shared by the DSM 102 and client node 108. Because the DSM 102 receives client file event records rather than entire client file contents, the amount of data sent by the client node 108 and accessed by the DSM 102 is smaller than the amount of data contained in client file. In at least one embodiment, the amount of data is less than 1% of the amount of data contained in the client file. Thus, sending the client file event record 114 rather than an entire client file 112 is far more efficient and requires far less client node 108 resources and less network bandwidth and data transfer.

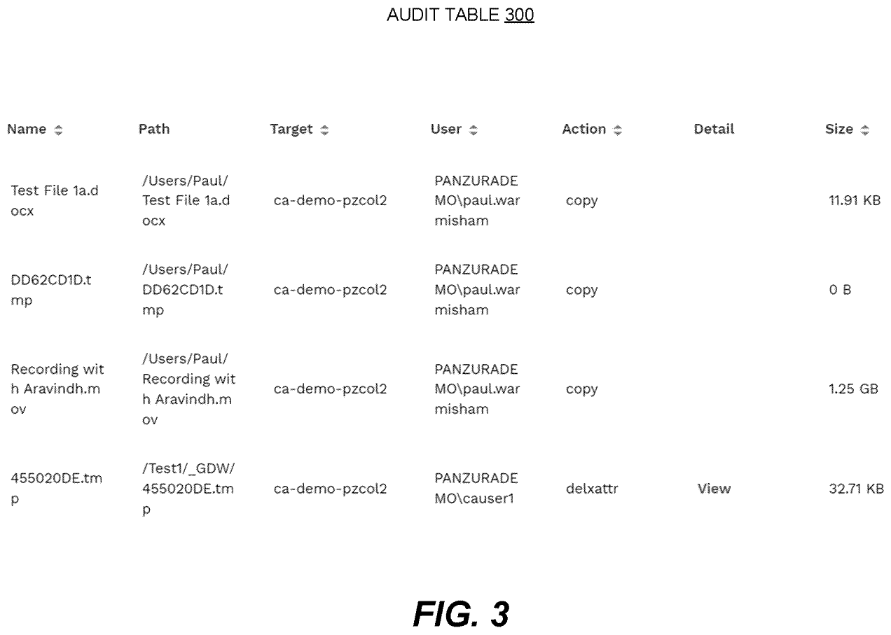

FIG. 3 depicts an exemplary audit table 300 with 4 rows of client file event records 114 and 7 columns of specific client event data. Each client event record 114 in audit table 300 contains of a file name, file path, client node identifier, user, event, event details, and file size. The particular client file event records used to detect a potential data security event are a matter of design choice and, in at least one embodiment, are of a small enough size to have a negligible impact of client node 108 resources.

Referring to FIGS. 1 and 2, in operation 206, the DSM 102 monitors one or more of the client file event records 114 for certain data security indicators present, whether evident or inferred, in an individual client event record 114 or from multiple client event records 114. The data security indicators include particular cell values in the client, file event records 114 or trends in values that indicate a data security event such as malicious tampering with the client files 112 or other anomalous activity involving the client files 112 and indicated in the client file event records 114. Malicious tampering with the client files 112 includes various activity types such as loss of data, unauthorized use, access, deletion, encryption, copying, creation, writing, transferring, moving, or reading data or file attributes including metadata, restricting or limiting access to data via breaches of a file system or otherwise, and any other unauthorized interaction with data or to a file system.

Individual data security breaches may be diverse in design, method, goals, or outcomes, but data security breaches all have something in common. Data security breaches often involve anomalous file system activity that can manifest in changes to targeted files. Thus, in at least one embodiment, the DSM system 102 manages detecting data security events by monitoring for anomalous activity associated with the client files 112. However, conventionally installing software in a client node that monitors all changes in a file system for anomalous activity requires significant computational processing resources that can significantly slow a client node. “Malicious tampering” of the client files 112 can also tampering with a file system used to organize and store data.

In at least one embodiment, anomalous activity indicated in one or more of the client file records 114 includes:
a content mismatch in the client file between a type of content of the client file and an extension of a name of the client file;
a signature or file fingerprint indicating an encrypted file;
at least one of the client, files is an undetectable type of file;
at least one of the client files has an, extension known to correspond to an extension associated with a ransomware attack; and
a user entity of the client node deviating from a predetermined normal file interaction behavior of the user entity, wherein the file interaction behavior of the user entity includes one or more of file read/writes, abnormal number of file deletions, abnormal number of reads of files not normally accessed by the user entity, files accessed, files deleted, and files renamed.

In at least one embodiment the DDSEDR system 100 determines predetermined normal file interaction behavior of a user entity by building a record of user entity file interaction, behaviors of each user entity with the client nodes 108. The record indicates normal file interaction behavior for each user entity over a period of time. For example, if a user entity normally writes to 200 files per day, the predetermined normal file ‘write’ interaction of the user entity is 200 files per day times a factor, such as one or two times a standard deviation factor to account for normal daily variations. In at least one embodiment, the user entity is one or more of an individual user of one or more client nodes, multiple users of one or more of the client nodes, and one or more users of multiple client nodes.

In some embodiments, the DSM 102 receives client file event records 114 associated with client files 112 whether write activity has occurred in the client files 112. If the number of files that are written to, significantly exceeds a user entity's normal write activity (for example the client normally writes to 200 files in a day but 1,000 files in a given day have write activity) or exceeds a set threshold for a user entity of a client node 108, the excess could be indicative of a data security event, such as a ransomware attack. In at least one embodiment, the user entity is one or more of an individual user of one or more client nodes, multiple users of one or more of the client nodes, and one or more users of multiple client nodes. The DSM 102 will flag several client files 112 during the heightened write activity period for inspection by the CDSECR 106.

Client file 112 deletion events can also indicate a potential data security event. In some embodiments, the DSM 102 receives client file event records 114 indicating a file has been deleted. If the number of files that are deleted significantly exceeds a user entity's normal delete activity (for example the user entity normally deletes to 100 files in a day but 500 files in a particular day are deleted), or exceeds a user entity's set threshold, the excessive deletions could be indicative of malevolent destruction of files.

Another data security event involves an anomalous amount of file copying. The client file event records 114 can include copying as an activity. If a user entity copies a number of client files 112 that significantly exceeds a client entity's normal copy activity (for example the client normally copies to 100 files in a day but 500 files in a particular day are copied), or exceeds a client entity's set threshold, the excessive copies could be indicative of espionage.

In some embodiments, the DSM 102 will retain log information related to anomalous activity and/or other potential and confirmed data security events, which can be used to predict a source and spread of certain attacks to anticipate attacks in other client nodes 108. For instance, the log information from a ransomware attack may indicate that the attack began with a particular file, a particular user, or at a particular time.

In at least one embodiment the DSM 102 can also assess changes in file entropy to detect a potential data security event. In at least one embodiment, every client file 112 has a header, a specific fingerprint, or both a header and a specific fingerprint and once the client file 112 is encrypted, the specific fingerprint changes or is deleted. Encryption of a file is an indication of a data security event, such as a ransomware attack where files are encrypted and require the malicious actor to provide information to decrypt the client files 112. To detect an indication of a potential data security event involving encryption of the one or more client files 112 associated with a client file record 114 includes at least one of:
determining if a previously recorded fingerprint of the client file has changed or has been deleted, determining if the fingerprint correctly corresponds to contents of the client file, and detecting a data security event if the fingerprint does not correctly correspond to the contents of the client file;
comparing an entropy score of the client file to an expected entropy score for a file type of the client file, determining if the entropy score and expected entropy score match, and detecting a data security event if the entropy score does not match the expected entropy score; and/or
determining and storing an original entropy score of the client file, detecting activity involving the client file, determining a new entropy score of the client file after detecting the activity, comparing the original entropy score of the client file to the new entropy score, determining if the original entropy score and the new entropy score match, and detecting a data security event if the original entropy score does not match the new expected entropy score.

In at least one embodiment of operation 208, when the DSM 102 determines that a client file 112 has been generated or renamed based on information in the client file event records 114, the DSM 102 uses an algorithm or logic matrix to compare an extension of the client file 112 with a list of known ransomware extensions. If the DSM 102 detects any of the known ransomware extensions, the DSM 102 flags the client file 112 as ransomware, incorporates the event into a blacklist detection score, and the DSM 102 hands off further processing to the CDSECR system 106 as described in more detail below.

Anomalous file deletion activity is also an example of anomalous activities monitored for by the DSM 102. If a user entity deletes a number of files that significantly exceeds the user entity's normal delete activity (for example the user entity normally deletes up to 100 files in a day but 500 files in a particular day are deleted), or exceeds a user entity's set threshold for deletions, the excessive deletions could be indicative of malevolent destruction of client files 112. If the DSM 102 detect this potential data security event of anomalous file deletion activity, the DSM 102 hands off further processing to the CDSECR system 106.

In some embodiments, the DSM 102 receives client file event records 114 indicating a client file 112 has been copied. The DSM 102 determines from a number of copy events in the client file event records 114 by the user entity significantly exceeds a user entity's normal copy activity (for example the client normally copies to 100 files in a day but 500 files in a particular day are copied), or exceeds a user entity's set threshold, the excessive copies could be indicative of espionage. If the DSM 102 detect this exemplary potential data security event of anomalous file copying activity, the DSM 102 hands off further processing to the CDSECR system 106.

In some embodiments, the CDSECR 106 retains log information related to anomalous activity or confirmed malicious processes, which can be used, to predict the source and, spread, of certain attacks, which can be used in anticipate attacks in other client nodes. For instance, the log, information from a ransomware attack may indicate that the attack began with a particular file, a particular user, or at a particular time.

When a potential data security event is detected by the DSM system 102 in operation 210, the DSM system 102 system provides PDSE information 118 to the CDSECR system 106 and hands off further processing to the CDSECR system 106. The PDSE information 118 includes command information to activate the CDSECR system 106 to confirm whether or not an actual data security event has occurred. As previously discussed, in at least one embodiment, the CDSECR system 106 is a component, such as an executing software application, of the client node 108. In operation 210, upon detection by the DSM 102 of the potential data security event, DSM 102 sends PDSE information 118 to the client computing environment 104 that activates and causes the CDSECR system 106 in operation 212, to inspect the one or more client files 112 associated with the potential data security event to determine whether an actual data security event occurred. In at least one embodiment, the DSM 102 also sends the basis for inspecting the one or more client files 112 associated with the potential data security event, such as encryption, file type change, content mismatch in the client file between a type of content of the client file and an extension of a name of the client file, and other indications of malicious tampering and other anomalous activity indicating a data security event as previously discussed with reference to operation 208 by the DSM 102.

In operation 214, the CDSECR system 106 then determines whether a data security event involving any of the one or more inspected client files 112 actually occurred. For example, the CDSECR system 106 accesses the client file 112 data associated with the flagged client file event record 114 and confirms the detection by using any single or combination of ransomware techniques such as: determining whether the file content matches the file name or extension, determining if the file is readable, analyzing the file entropy and comparing the entropy to a scoring system, processing an image file through an Image Artificial Intelligence program to detect any images present, searching a document containing text for known words, or any other technique that can be employed to confirm whether a file has been encrypted.

In another embodiment, if the DSM 102 detects excessive copying of client files 112, which may indicate espionage or other unauthorized activity, the PDSE information 118 sent by the DSM 102 to the CDSECR system 106 includes a log of copied files, during the period of excessive copying. Based on the PDSE information 118 sent by the DSM 102 to the CDSECR 106 in operation 210, the CDSECR system 106 will initially disable read and write privileges to any client, node 108 and client files 112 for the user entity associated with anomalous copying of the client files 112. In at least one embodiment, the CDSECR system 106 will alert the user entity and/or other designed alert recipient 120 with an alert 122, of the excessive copying determination in operation 216. In at least one embodiment, the CDSECR 106 awaits information, such as instructions, from the alert recipient(s) 120 to take action in, response of an actual data security event. In at least one embodiment, the CDSECR 106 utilizes rules-based programming and/or artificial intelligence to take action or recommend action to the alert recipient(s) 120 if the CDSECR 106 confirms that the copying was an actual data security event. If the CDSECR 106 confirms that the copying was an actual data security event, the CDSECR 106 maintains disablement of the user entity's read and write privileges. If the CDSECR system 106 indicates that the excessive copying was not an actual data security event, such as espionage, the CDSECR system 106 will restore read and write privileges to the user entity associated with excessively copying the files.

If a user entity threshold is reached for malevolent destruction, in at least one embodiment, the CDSECR system 106 will disable read and write privileges for the user associated with deleting the files and will send an alert 122 to the alert recipient 120 informing the alert recipient 120 of the deletions. The alert recipient 120 is a matter of design choice and is, for example, an information technologist managing or otherwise involved with the DDSEDR system 100 system and/or any other one or more predefined alert recipients 120. If the client node confirms that the deletions were malevolent destruction, the CDSECR system 106 instructs the client node 108 to restore the deleted files from a backup to a time period immediately prior to the heightened deletion activity or to a time period based on the client preferences. If the CDSECR system 106 indicates that the deletions were not malevolent destruction, the CDSECR system 106 will restore read and write privileges to the user associated with deleting the files.

In operation 216, when the CDSECR system 106 determines an actual data security event occurred, the CDSECR system 106 generates a responsive action. If a suspected malicious process or other suspected data security event causes an actual data security event in a file system, in at least one embodiment, the CDSECR system 106 stops further damage associated with the data security event as soon as possible to limit any damage and support mitigation and recovery efforts.

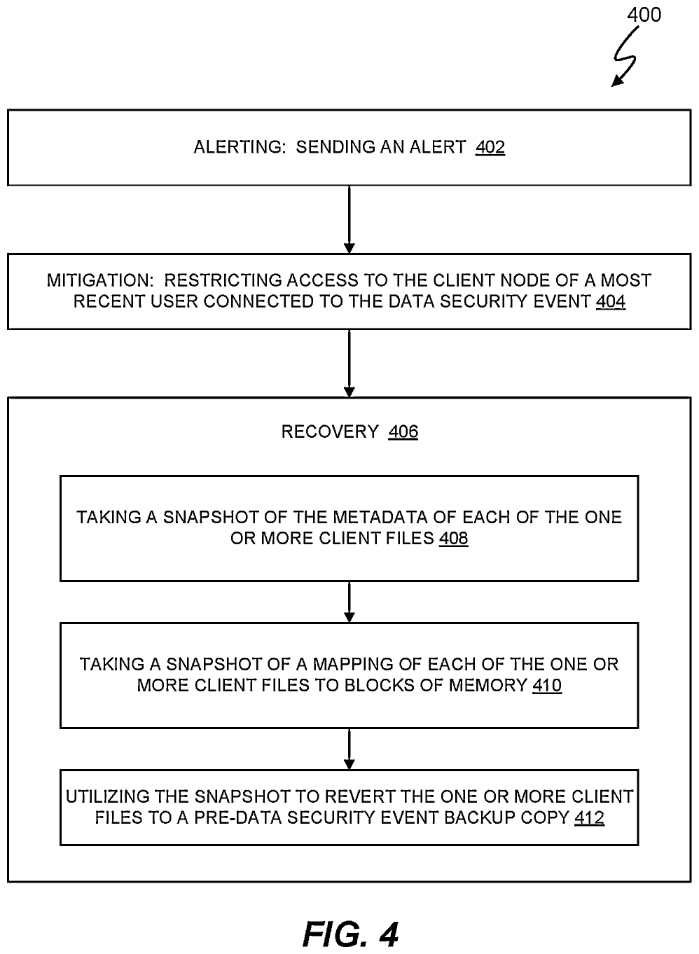

FIG. 4 depicts exemplary responsive actions 400 taken by the CDSECR system 106 determines an actual data security event occurred. The responsive actions can be separate or cumulative. In responsive action 402, the CDSECR system 106 sends an alert 122 to a predesignated destination or destinations, such as information technologist, that the CDSECR system 106 has detected and confirmed a data security event. The alert 122 may also include actions to stop, mitigate, and/or recover data already initiated by or recommended by the CDSECR system 106. In responsive action 404, the CDSECR system 106 restricts access to the client node 108 used by a most recent user entity connected to the data security event. For example, if the DSM 102 PDSE information 118 also indicates that a predetermined threshold of copying has been reached for espionage in at least one embodiment, the CDSECR system 106 will disable read and write privileges for the user entity associated with copying the client files 112 and will alert the alert recipient(s) 120, such as an information technologist or a machine controller, to the excessive copying.

If the CDSECR system 106 confirms encryption of a client file 112, the CDSECR system 106 adds the file name and location of the client file 112 to a confirmed ransomware log. If the client file 112 has an extension that is neither on a blacklist or whitelist (non-ransomware extensions), the CDSECR system 106 adds this suspect extension list to the blacklist or a suspect list as needed. If a number of entries in the ransomware log exceeds a defined threshold, the CDSECR system 106 instructs the client nodes 108 to make a snapshot of the client computing environment 104 and send an alert 120 to alert the alert recipient(s) 120 of the threat, based on the client's alert preferences. If the client computing environment 104 to respond, or the user entity's threshold for action is exceeded, the CDSECR system 106 will initiate a data security breach detection protocol by, for example, either disable read and write privileges for the user entity responsible for modifying the client files 112 which generated the alert or, based on CDSECR system 106, disable read and write privileges for all users of a client node 108 and/or a client computing environment 104. Once the CDSECR system 106 does not detect any new infected client files 112 after a defined period of time, in at least one embodiment, the CDSECR system 106 initiates a recovery protocol. In at least one embodiment of the recovery protocol, the CDSECR system 106 parses through the ransomware or anomaly logs determining the first detected and confirmed anomaly. Depending on the client computing system 104 preference, the CDSECR system 106 instructs client nodes 108 to either roll back all files to a time prior to the attack or roll back just the infected files. After the client computing system 104 is restored from the attack, the CDSECR system 106 restores read write privileges or waits to restore read write privileges until the client computing system 104 confirms the recovery.

In responsive action 406, the CDSECR system 106 performs the following operations 408, 410, and 412 to mitigate and/or recover client files 112 affected by the data security event:
Operation 408: taking a snapshot of the metadata of each of the one or more client files;
Operation 410: taking, a snapshot of a mapping of each of the one or more client files to blocks of memory; and
Operation 412: utilizing the snapshot to revert the one or more client files to a pre data security event backup copy.

Thus, embodiments of the DDSEDR system 100 provide real-time detection, confirmation, mitigation, alerting, and recovery from data security events including malicious processes, in a manner that minimizes any computational burden to a client computing environment 104 while at the same time not removing any data from the client computing environment 104. In at least one embodiment, one or more components of the DDSEDR system 100 system, such as the DSM 102 and the client computing environment 104, operate in a cloud environment. In at least one embodiment, the DSM 102 maintains a synchronized file system containing client file event records 114 for all client files 112. In at least one embodiment, a cloud file system (CFS) (not shown) in the client computing environment 104 manages data files of the client nodes 108. In at least one embodiment, the CFS and the DSM 102 have synchronized client file event records 114. As client files 112 are modified by a client node 108, a snapshot of the client file event records 114 associated with the client files 112 is sent by the CFS to the DSM 102. The DSM 102 evaluates the client file event records 114 based on, for example, the information contained in the client file event records 114 and/or client file event records 114 changes over time. When the DSM 102 detects a potential data security event, the DSM 102 causes the client computing environment 104 to initiate a data security event continuation process where data is inspected by the CDSECR system 106, which means privacy and confidentiality is maintained as no primary file content data leaves the client computing environment 104. In at least one embodiment, the DSM 102 includes a multi-tenant cloud controller (MTCC) that performs embodiments of the described DSM operations as, for example, described in U.S. Provisional Application No. 63/376,727.

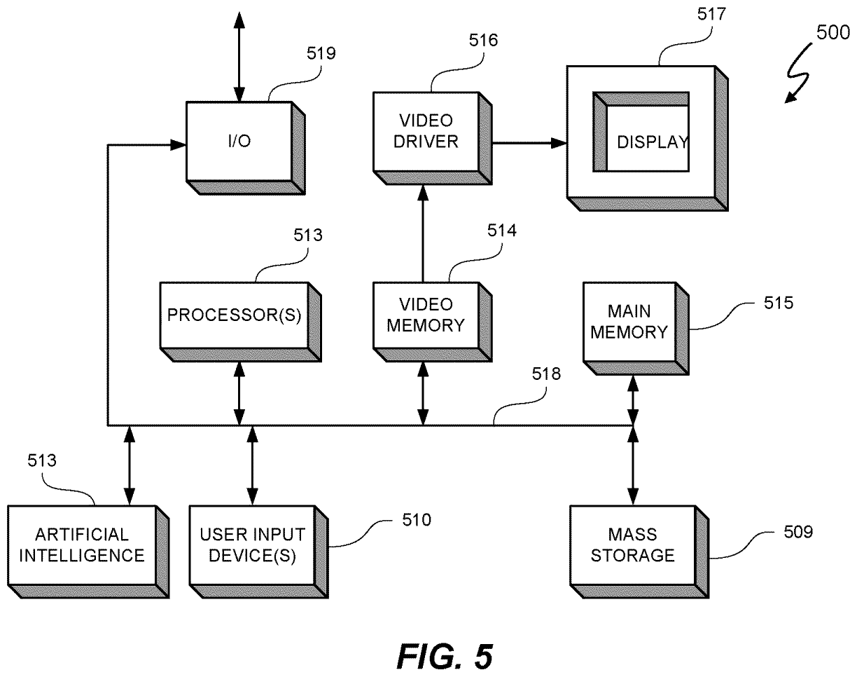

Embodiments of the distributed data security event detection and response system 100 can be implemented on specially programmed computer systems such as the special purpose computer system 500 depicted in FIG. 5. The computer system 500 can be a dedicated, computer system or a virtual, emulated system located in, for example, a cloud computing environment. Input user device(s) 510, such as a keyboard and/or mouse, are coupled to a bi-directional system bus 518. The input user device(s) 510 are for introducing input to the computer system and communicating that user input to one or more processors 513. The computer system 500 generally also includes a non-transitory video memory 514, non-transitory main memory 515, and non-transitory mass storage 509, all coupled to bi-directional system bus 518 along with input user device(s) 510 and the processor(s) 513. The mass storage 509 may include both fixed and removable media, such as a hard drive, one or more CDs or DVDs, solid state memory including flash memory, and other available mass storage technology. Bus 518 may contain, for example, 32 of 64 address lines for addressing video memory 514 or main memory 515. The system bus 518 also includes, for example, an n-bit data bus for transferring DATA between and among the components, such as CPU 509, main memory 515, video memory 514 and mass storage 509, where “n” is, for example, 32 or 64. Alternatively, multiplex data/address lines may be used instead of separate data and address lines. The special purpose computer system 500 may also include an artificial intelligence 513 component or be coupled to a system (not shown) that provides artificial intelligence services.

I/O device(s) 519 may provide connections to peripheral devices, such as a printer, and may also provide a direct connection to a remote server computer systems via a telephone link or to the Internet via an ISP. I/O device(s) 519 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in a non-transitory computer readable medium such as a flash memory, optical memory, magnetic memory, compact disks, digital versatile disks, and any other type of memory. The computer program is loaded from a memory, such as mass storage 509, into main memory 515 for execution.

The processor 513, in one embodiment, is a microprocessor manufactured by Motorola Inc. of Illinois, Intel Corporation of California, or Advanced Micro Devices of California. However, any other suitable single or multiple microprocessors or microcomputers may be, utilized. Main memory 515 is comprised of dynamic random access memory (DRAM). Video memory 514 is a dual-ported video random access memory. One port of the video memory 514 is coupled to video amplifier 516. The video amplifier 516 is used to drive the display 517. Video amplifier 516 is well known in the art and may be implemented by any suitable means. This circuitry converts pixel DATA stored in video memory 514 to a raster signal suitable for use by display 517. Display 517 is a type of monitor suitable for displaying graphic images.

The computer system described above is for purposes of example only. It is contemplated that the DDSEDR system 100 might be run on a stand-alone computer system, such as the one described above. The computer system 500 may be a cloud-based virtual machine. The DDSEDR system 100 might also be run from one or more server computer systems that can be accessed by a plurality of client computer systems interconnected over an intranet network. Finally, the DDSEDR system 100 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of managing data security events, the method comprising:
accessing, with a data security management (DSM) system, one or more client file event records, wherein:
each client file event record is uniquely associated with a client file;
the client node is separate from the DSM system;
each of the client files includes primary file content separate from the associated client file event record; and
the client file event record logs information directly related to the associated client file;
monitoring the one or more client file event records with the DSM system;
detecting an indication of a potential data security event involving the one or more client files associated with the client file record; and
upon detection by the DSM of the potential data security event, sending information to a client computing environment that causes a client-side data security event confirmation and response (CDSECR) system to inspect the one or more client files associated with the potential data security event to determine whether an actual data security event occurred and initiate a responsive action when the CDSECR determines an occurrence of an actual data security event.

2. The method of claim 1 wherein each cloud file event record contains a file name, file path, client node identifier, user entity, event, event details, and file size.

3. The method of claim 2 wherein each client, file event record is a record in an event audit table.

4. The method of claim 1 wherein each cloud file event record includes a file name, a multipurpose Internet Mail Extension (MIME) type, an event time, and an activity type.

5. The method of claim 1 wherein if inspection of the client file data record indicates malicious tampering, activating a client taking protective action.

6. The method of claim 1 wherein the data security event is an anomalous activity that comprises at least one of:
a. a content mismatch in the client file between a type of content of the client file and an extension of a name of the client file;
b. a signature or file fingerprint indicating an encrypted file when the signature or file fingerprint is not expected to have encrypted content;
c. at least one of the client files is encoded in a binary file format and the client files are unintelligible;
d. at least one of the client files is an undetectable type of file;
e. at least one of the client files has an extension known to correspond to an extension associated with a ransomware attack; and
f. a user entity of the client node deviating from a predetermined normal file interaction behavior of the user entity, wherein the file interaction behavior of the user entity includes one or more of file read/writes, abnormal number of file deletions, abnormal number of reads of files not normally accessed by the user entity, files accessed, files deleted, and files renamed.

7. The method of claim 6 wherein every client file has a header, a specific fingerprint, or both a header and a specific fingerprint and once the client file is encrypted, the specific fingerprint changes or is deleted, wherein to detect an indication of a potential data security event involving encryption of the one or more client file associated with the client file event record further comprises at least one of:
A. determining if a previously recorded fingerprint of the client file has changed or has been deleted;
determining if the fingerprint correctly corresponds to contents of the client file; and
detecting a data security event if the fingerprint does not correctly correspond to the contents of the client file;
B. comparing an entropy score of the client file to an expected entropy score fora file type of the client file;
determining if the entropy score and expected entropy score match; and
detecting a data security event if the entropy, score does not match the expected entropy score.
C. determining and storing an original entropy score of the client file;
detecting activity involving the client file;
determining a new entropy score of the client file after detecting the activity;
comparing the original entropy score of the client file to the new entropy score;
determining if the original entropy score and the new entropy score match; and
detecting a data security event if the original entropy score does not match the new expected entropy score.

8. The method of claim 7 wherein to determine whether an actual data security event occurred comprises one or more of steps a-f and A-C.

9. The method of claim 6 wherein a user entity is one or more of an individual user of one or more client nodes, multiple users of one or more of the client nodes, and one or more users of multiple client nodes, the method further comprising for one or more of the user entities:
building a file of file interaction behaviors of the user entity of the client node to determine a normal file interaction behavior for each entity over a period of time; and
deriving the predetermined normal file interaction behavior of the user entity from the determined normal file interaction behavior for each user entity.

10. The method of claim 1 wherein the responsive action comprises at least one of:
a. sending an, alert;
b. restricting access to the client node used by a most recent user entity connected to the data security event;
c. taking a snapshot of the metadata of each of the one or more client files;
taking a snapshot of a mapping of each of the one or more client files to blocks of memory; and
utilizing the snapshot to revert the one or more client files to a pre-data security event backup copy.

11. The method of claim 1 wherein the data security event is a ransomware attack.

12. The method of claim 1 wherein the one or more client file event records are created by the client node and stored in an audit table in a folder shared by the DSM system and the client node and accessing the one or more client file event records comprises:
accessing the audit table in the shared folder.

13. The method of claim 1 further comprising:
inspecting in the client node the one or more client files directly to determine whether an existence of an actual data security event occurred; and
generating the responsive action if the client node detects the actual data security event.

14. A distributed data security event detection and response system, the system comprising:
data security management (DSM) system comprising one or more processors and a memory, coupled to one or more, processors, wherein the memory includes stored code that when executed by the one or more processors causes the DSM system to perform operations comprising:
accessing one or more client file event records, wherein:
each client file event record is uniquely associated with a client file;
the client node is separate from the DSM system;
each of the client files includes primary file content separate from the associated client file event record; and
the client file event record logs information directly related to the associated client file;
monitoring the one or more client file event records with the DSM system;
detecting an indication of a potential data security event involving the one or more client files associated with the client file record; and
upon detection by the DSM of the potential data security event, sending information to a client computing environment that causes a client-side data security event confirmation and response (CDSECR) system to inspect the one or more client files associated with the potential data security event to determine whether an actual data security event occurred and initiate a responsive action when the CDSECR determines an occurrence of an actual data security event.

15. The system of claim 14 wherein each cloud file event record contains a file name, file path, client node identifier, user entity, event, event details, and file size.

16. The system of claim 14 wherein each client file event record is a record in an event audit table.

17. The system of claim 14 wherein each cloud file event record includes a file name, a multipurpose Internet Mail Extension (MIME) type, an event time, and an activity type.

18. The system of claim 14 wherein if inspection of the client file data record indicates malicious tampering, activating a client taking protective action.

19. The system of claim 14 wherein the data security event is an anomalous activity that comprises at least one of:
a. a content mismatch in the client file between a type of content of the client file and an extension of a name of the client file;
b. a signature or file fingerprint indicating an encrypted file when the signature or file fingerprint is not expected to have encrypted content;
at least one of the client files is encoded in a binary file format and the client files are unintelligible;
d. at least one of the client files is an undetectable type of file;
e. at least one of the client files has an extension known to correspond to an extension associated with a ransomware attack; and
f. a user entity of the client node deviating from a predetermined normal file interaction behavior of the user entity, wherein the file interaction behavior of the user entity includes one or more of file read/writes, abnormal number of file deletions, abnormal number of reads of files not normally accessed by the user entity, files accessed, files deleted, and files renamed.

20. The system of claim 19 wherein every client file has a header, a specific fingerprint, or both a header and a specific fingerprint and once the client file is encrypted, the specific fingerprint changes or is deleted, wherein to detect an indication of a potential data security event involving encryption of the one or more client file associated with the client file event record further comprises at least one of:
A. determining if a previously recorded fingerprint of the client file has changed or has been deleted;
determining if the fingerprint correctly corresponds to contents of the client file; and
detecting a data security event if the fingerprint does not correctly correspond to the contents of the client file;
B. comparing an entropy score of the client file to an expected entropy score for a file type of the client file;
determining if the entropy score and expected, entropy score match; and
detecting a data security event if the entropy score does not match the expected entropy score.
C. determining and storing an original entropy score of the client file;
detecting activity involving the client file;
determining a new entropy score of the client file after detecting the activity;
comparing the original entropy score of the client file to the new entropy score;
deter lining if the original entropy score and the new entropy score match; and
detecting a data security event if the original entropy score does not match the new expected entropy score.

21. The system of claim 20 wherein to determine whether an actual data security event occurred comprises one or more of steps a-f and A-C.

22. The system of claim 19 wherein a user entity is one or more of an individual user of one or more client nodes, multiple users of one or more of the client nodes, and one or more users of multiple client nodes, the system further comprising for one or more of the user entities:
building a file of file interaction behaviors of the user entity of the client node to determine a normal file interaction behavior for each entity over a period of time; and
deriving the predetermined normal file interaction behavior of the user entity from the determined normal file interaction behavior for each user entity.

23. The system of claim 14 further comprising a client-side data security event confirmation and response system (CDSECR), wherein the CDSECR system includes one or more processors and a memory, coupled to the one or more processors, that includes code that when executed by the one or more processors causes the one or more processors to perform operations comprising:
receiving the information from the DSM; and
performing a response action, wherein the responsive action comprises:
determining if an actual data security event occurred; and
when an actual data security event occurs, performing one or more responsive actions comprising:
a. sending an alert;
b. restricting access to the client node used by a most recent user entity connected to the data security event;
c. taking a snapshot of the metadata of each of the one or more client files;
taking a snapshot of a mapping of each of the one or more client files to blocks of memory; and
utilizing the snapshot to revert the one or more client files to a pre-data security event backup copy.

24. The system of claim 14 wherein the data security event is a ransomware attack.

25. The system of claim 14 wherein the one or more client file event records are created by the client node and stored in an audit table in a folder shared by the DSM system and the client node and accessing the one or more client file event records comprises:
accessing the audit table in the shared folder.

26. The system of claim 14 further comprising a client-side data security event confirmation and response system (CDSECR), wherein the CDSECR system includes one or more processors and a memory, coupled to the one or more processors, that includes code that when executed by the one or more processors causes the one or more processors to perform operations comprising:
inspecting in the client node the one or more client files directly to determine whether an existence of an actual data security event occurred; and
generating the responsive action if the client node detects the actual data security event.

27. A non-transitory, computer readable medium having code stored therein to manage data security events, wherein when execution of the code by one, or more processors causes the one or more processors to perform operations comprising:
accessing, with a data security management (DSM) system, one or more client file event records, wherein:
each client file event record is uniquely associated with a client file;
the client node is separate from the DSM system; and
each of the client files includes primary file content separate from the associated client file event record; and
the client file event record logs information directly related to the associated, client file;
monitoring the one or more client file event records with the DSM system;
detecting an indication of a potential data security event involving the one or more client files associated with the client file record; and
upon detection by the DSM of the potential data security event, sending information to a client computing environment that causes a client-side data security event confirmation and response (CDSECR) system to inspect the one or more client files associated with the potential data security event to determine whether an actual data security event occurred and initiate a responsive action when the CDSECR determines an occurrence of an actual data security event.
